(19) United States
(12) Patent Application Publication
(10) Pub. No.: US 2014/0001773 A1
(43) Pub. Date: Jan. 2, 2014

(54) SCREEN FRAME GRASPING AND REMOVAL SYSTEM

(71) Applicant: SCREENCO MANUFACTURING LTD., Concord (CA)

(72) Inventors: Jennifer SMALL, Concord (CA); Alfred MacLean, Kettleby (CA)

(73) Assignee: Screenco Manufacturing Ltd., Concord (CA)

(21) Appl. No.: 13/772,951

(22) Filed: Feb. 21, 2013

(30) Foreign Application Priority Data
Jun. 29, 2012 (CA) 2782425

(51) Int. Cl. E05C 1/00; E05C 1/10

(52) U.S. Cl. CPC E05C 1/004; E05C 1/10
USPC 292/175; 16/110.1

(57) ABSTRACT

In one embodiment the present invention is a screen frame grasping and removal system comprising at least one pull tab. There is at least one lock to lock each tab. The frame defines openings to receive the tab and lock cooperation, the tab and lock openings communicating with each other to permit the lock to engage the tab. In another embodiment the above includes one side of the frame defining an opening to receive the tab and an opening to receive the lock, the tab and lock openings communicating with each other to permit the lock to engage the tab; and a second side of the frame contains therein at least one outwardly springing bias. The screen first and second side opposing each other.

### FIELD OF THE INVENTION

This invention relates to screens generally for windows, and more specifically to a system for installing and removing screens.

### BACKGROUND

Numerous window and window frame types are available on the market. Screens either install on a building inside or outside (the building defining an opening for a window and screen between the inside and outside), and appear either in front of (meaning disposed toward the building inside) or behind (meaning disposed toward the building outside) the window. There are different window types depending on the frame, including slider, double, and single hung windows. Any screen appearing behind a window typically requires installation from outside the building. Prior art screen systems permit installation and removal from inside the building, but require pivoting metal clips. These clips can easily fall out of their guide slots, be lost, and are cumbersome to operate. The clips also have pointy ends, posing a safety hazard.

### SUMMARY OF THE INVENTION

In one embodiment the present invention is a screen frame grasping and removal system comprising at least one pull tab. There is at least one lock to lock each tab. The frame defines openings to receive the tab and lock cooperation, the tab and lock openings communicating with each other to permit the lock to engage the tab.

In another embodiment the present invention is a screen frame grasping and removal system comprising at least pull tab. There is at least one lock to lock each tab. One side of the frame defines an opening to receive the tab and an opening to receive the lock, the tab and lock openings communicating with each other to permit the lock to engage the tab. A second side of the frame contains therein at least one outwardly springing bias. The screen first and second side opposing each other.

### DRAWINGS

FIG. 1 is a prior art window screen showing pivoting metal clips.

FIG. 2 is an exploded perspective view of a pull tab and locking pin system.

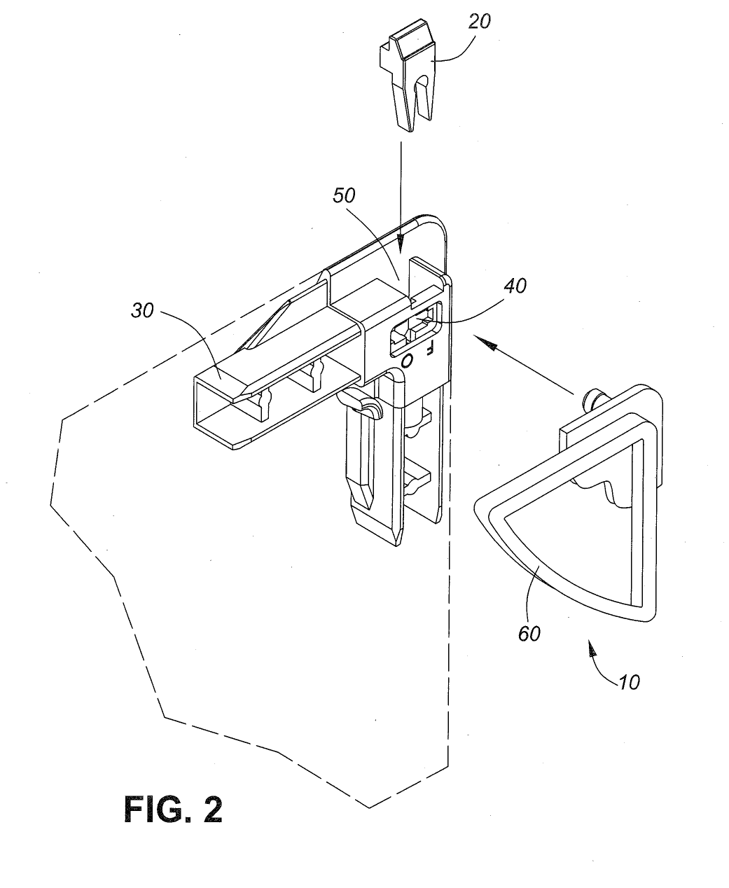

FIG. 3 is an exploded perspective view of spring loaded wedge system.

FIG. 4 is a perspective of a screen installation using a pull tab and locking pin system with opposing spring loaded wedges.

FIG. 5 is a plan view of a screen with a pull tab and locking pin system, and a spring loaded wedge system.

### DETAILED DESCRIPTION OF THE DRAWING

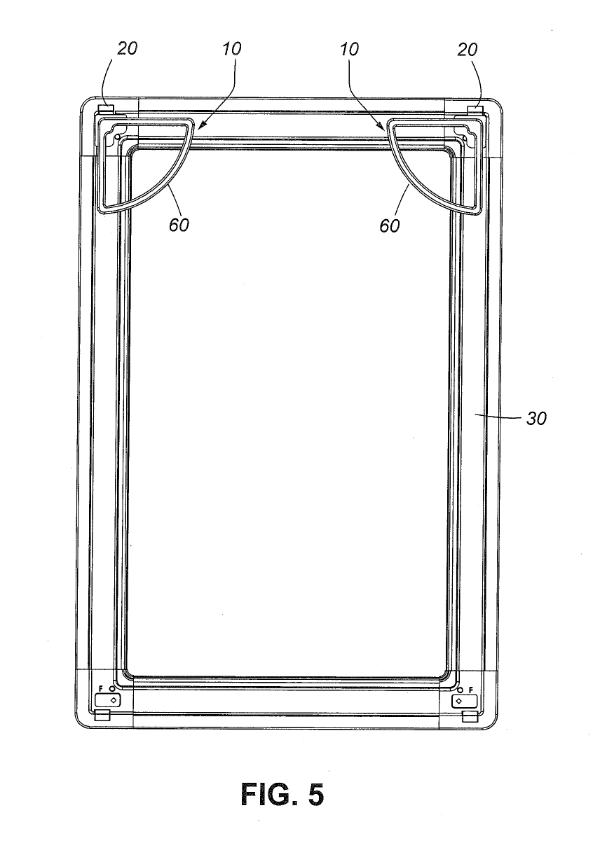

A screen frame grasping and removal system shown in FIG. 5 comprises at least one pull tab (10). There is also at least one lock to lock each tab (10) (one per tab (20)). The frame (30) defines tab and lock openings (40, 50) to receive the tab and lock (10, 20) cooperation, the tab and lock openings (40, 50) communicating with each other to permit the lock (20) to engage the tab (10).

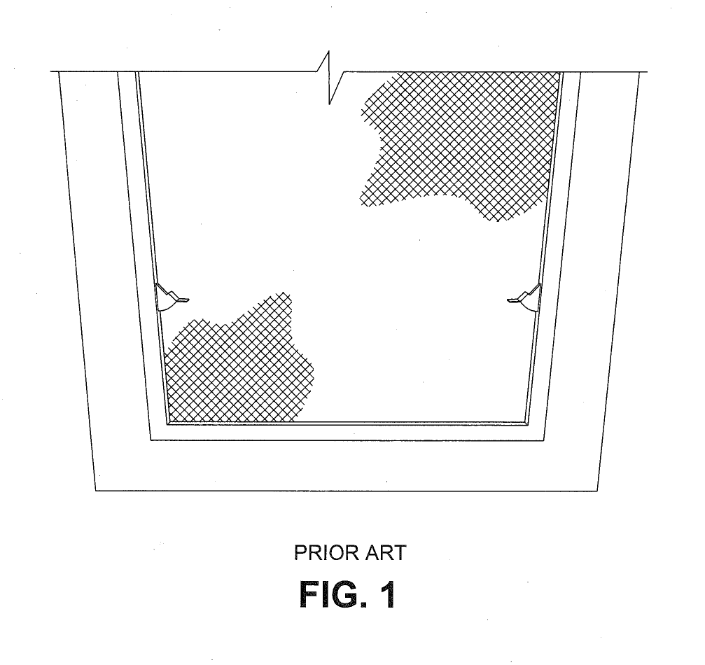

Most frames (30) are quadrilateral (like FIGS. 1, 4 and 5), but depending on engineering, the system could be applied to screens for unusual shaped windows (like oval). The lock and tab openings (40, 50) are adjacent a corner of the quadrilateral, in the configuration shown (FIG. 5).

The tab (10) comprises a handle (60), to grasp and pull on, and a pin (70) to project inward the tab opening (40). User fingers can pass through the tab (10) shown in FIG. 5, but other variants are possible such as a tongue (solid, no openings; not shown).

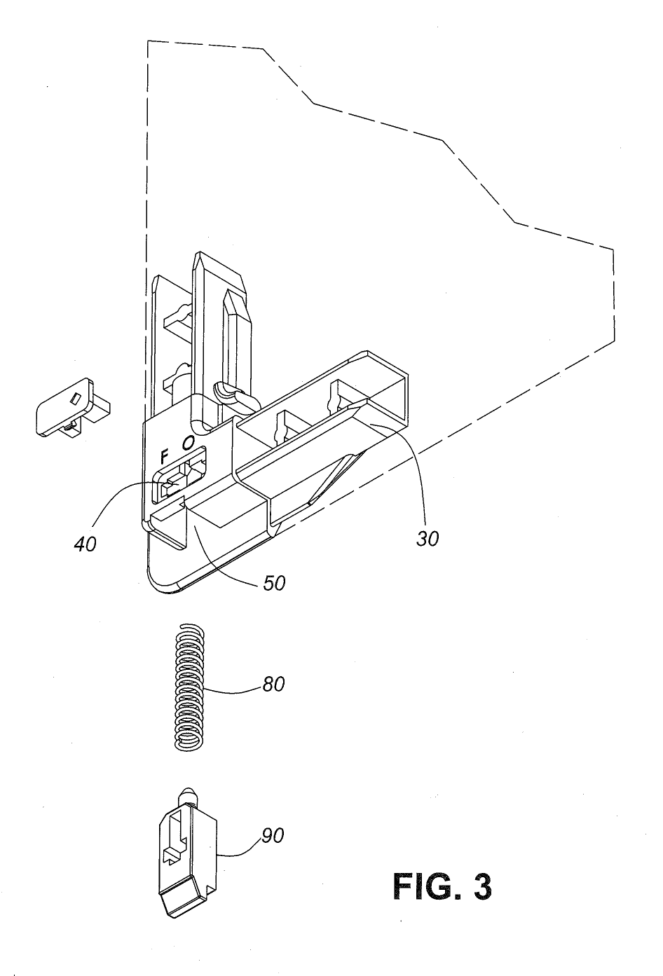

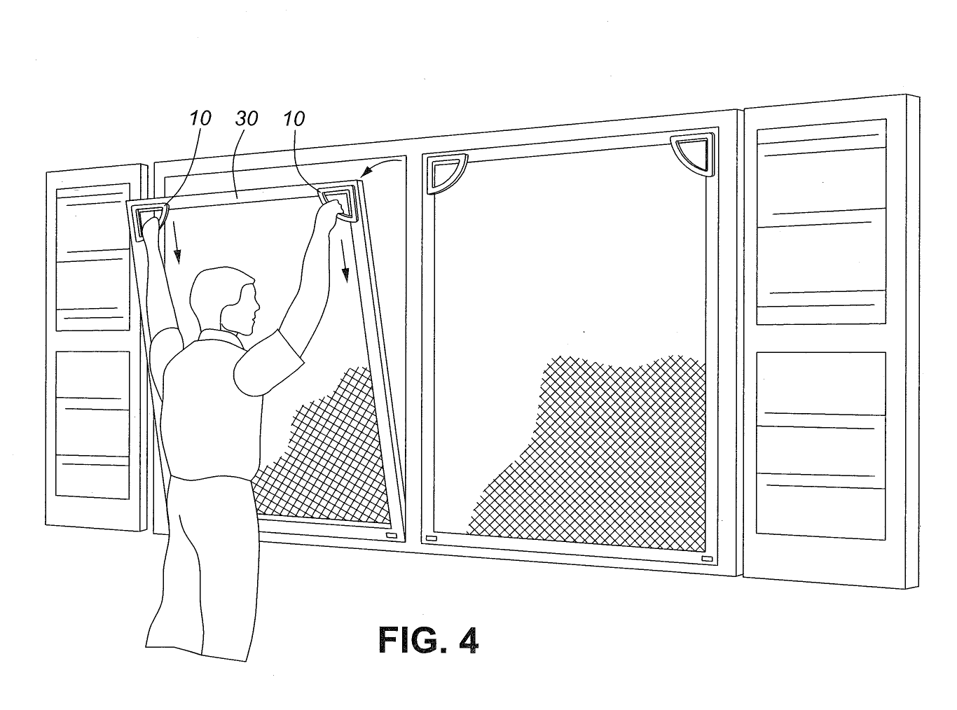

The tab (10) and lock (20) are, in FIG. 5, disposed toward one side of the frame. A second side of the frame can also be configured to have at least one outwardly springing bias, like in FIG. 3. In FIG. 3 specifically, the bias is in the form of a coiled spring (80) exerting against a wedge (90). The wedge (90) slides into grooves within window frames (not shown), to stabilize and support the screen frame. In FIG. 4, the first side opposes the second side, such that a user could pull “down” on the tabs (10) near the frame “top”, resulting in spring (80) and wedge (90) compression at the “bottom”. Such action permits either of installation or removal from the window frame.

What is claimed is:

1. A screen frame grasping and removal system comprising:
at least one pull tab;
at least one lock to lock each tab; and
wherein the frame defines openings to receive the tab and lock cooperation, the tab and lock openings communicating with each other to permit the lock to engage the tab.

2. The system in claim 1 wherein the frame is a quadrilateral.

3. The system in claim 1 wherein the pin and tab openings are adjacent a corner of the quadrilateral.

4. The system in claim 1 wherein the pin further comprises a handle, to grasp and pull for unlocking from the tab.

5. The system in claim 1 wherein the tab defines an opening, to pass fingers therethrough.

6. A screen frame grasping and removal system comprising:
at least one pull tab;
at least one lock to lock each tab;
wherein one side of the frame defines an opening to receive the tab and an opening to receive the lock, the tab and lock openings communicating with each other to permit the lock to engage the tab;
a second side of the frame contains therein at least one outwardly springing bias; and
the screen first and second side opposing each other.
